(19) United States
(12) Patent Application Publication
(10) Pub. No.: US 2001/0035982 A1
(43) Pub. Date: Nov. 1, 2001

(54) Image processor and storage medium

(75) Inventors: Takanobu Otsubo, Ebina-shi (JP); Hiroshi Sekine, Ebina-shi (JP); Hiroyuki Kawano, Ebina-shi (JP)

Correspondence Address: MORGAN, LEWIS & BOCKIUS, 1800 M STREET NW, WASHINGTON, DC, 20036-5869, US

(73) Assignee: Fuji Xerox Co, Ltd.

(21) Appl. No.: 09/841,023

(22) Filed: Apr. 25, 2001

(30) Foreign Application Priority Data
Apr. 27, 2000 (JP) 2000-127995

(51) Int. Cl. B41F 1/00; G06K 1/00; B41B 1/00

(52) U.S. Cl. 358/462; 358/1.14

(57) ABSTRACT

The present invention provides an image processor that enables recognition of a specific image such as an image of which the printing is prohibited at high speed and in addition, with high precision. Image data input to an image formation device is converted to output image data in a PDL conversion unit and it is determined in a preliminary determination unit whether a certain condition is met or not. Only if the certain condition is met, processing for recognizing the specific image is executed by a recognition unit. If the certain condition is not met, it is considered that the possibility of including the specific image is low and no processing for recognizing the specific image is executed. Therefore, the processing can be sped up by the quantity in which no recognition processing is executed. Also, as recognition processing is executed if the certain condition is met and there is the possibility of including the specific image, the precision of recognizing the specific image is never deteriorated.

### BACKGROUND OF THE INVENTION

1. Field of the Invention

The present invention relates to an image processor provided with a function for recognizing a specific image, an image processor that outputs image data to such a processor and a storage medium storing a program for implementing the function of such an image processor.

2. Description of the Related Art

Recently, the quality of an image of a color copying machine and a color printer, a function of a personal computer, the quality of an image of a scanner and others have been enhanced and it has also become possible to prepare a print of high quality with relative ease. Hereby, a problem that securities such as a bill and a ticket the copying of which is prohibited can be illegally copied by using these machines is caused.

To mainly prohibit such illegal copying, various methods of recognizing an image of which the printing is prohibited by digital image processing technology are proposed in documents such as Japanese Published Unexamined Patent Applications No. Hei 6-54186, No. Hei 6-225134, No. Hei 8-335267 and No. Hei 9-18709.

If a command for output is issued to a printer connected to a network, it is generally performed to represent print data in page description language (hereinafter called PDL). The printer connected to the network interprets sent PDL, generates raster data of resolution suitable for the resolution of the printer and finally prints an image on paper.

FIG. 12 is a flowchart showing an example of printing operation if processing for recognizing an image of which the printing is prohibited is executed by a printer. As described above, for technique for checking to see whether or not an image itself is an image of which the printing is prohibited, various methods are proposed. If these techniques are applied to a printer connected to a network, a procedure shown in FIG. 12 for example is executed.

In an example shown in FIG. 12, before PDL to be printed is rasterized in a step S61, it is determined whether or not an image of which the printing is prohibited is included and if an image of which the printing is prohibited is included, the whole page or an area in which the image of which the printing is prohibited is printed is blanked in a step S62 or a message that printing is prohibited is printed in S62. Also, if no image of which the printing is prohibited is included, PDL is converted in a step S63 as normally and is output.

FIG. 13 is a flowchart showing another example of printing operation if processing for recognizing an image of which the printing is prohibited is executed by a printer. In FIG. 12, it is determined whether or not the corresponding image is an image of which the printing is prohibited before rasterization, however, it can also be determined whether a rasterized image is an image of which the printing is prohibited or not. In a step S71, PDL to be printed is rasterized and it is determined in a step S72 whether or not an image of which the printing is prohibited is included in the rasterized image. If no image of which the printing is prohibited is included, the image rasterized in S71 is formed on paper for example in a step S74. Also, if an image of which the printing is prohibited is included, the whole page or an area of the image of which the printing is prohibited is blanked in a step S73 or a message that printing is prohibited is printed in S73.

If the image of which the printing is prohibited is included in print data, the image can be determined by such processing so that it is not printed. However, in the processing shown in FIGS. 12 and 13 or the conventional type recognition processing of an image of which the printing is prohibited, it is determined whether or not all print data is an image of which the printing is prohibited. Therefore, there is a problem that time required for printing and output is extended.

Particularly, to strictly recognize an image, more complex processing by the quantity is required to be executed, and the enhancement of recognition precision and time required for output have reciprocal relation. When recognition processing is applied to a raster image for printing for one page for example, it takes approximately ten and several to several tens seconds and in consideration of the recent speedup of an output device, such a long processing time cannot be allowed.

### SUMMARY OF THE INVENTION

The present invention is made in view of the situation described above and provides an image processor that can recognize a specific image such as an image of which the printing is prohibited at high speed and in addition, with high precision and a computer-readable storage medium storing a program for making a computer execute the function of such an image processor.

In the invention, only if a certain condition of whether a raster image for example exists in input image data or not, whether the input image data includes a predetermined characteristic or not or whether or not a mode in which an image is output is a predetermined mode is met, processing for recognizing the specific image is executed. Hereby, as no recognition processing is executed if it is clearly conceived that no specific image is included for example, the whole processing can be sped up and the specific image can be recognized without deteriorating the recognition precision.

For the predetermined characteristic included in image data used for determining whether the recognition of the specific image is tried or not, the size, the resolution, the number of colors, a compression format and others after output in the case of a raster image for example are conceivable. If these are greatly different from the characteristic of the specific image or if these characteristics cause no problem even if the specific image based upon them is output, recognition processing can be omitted for speedup. If the size or the number of colors after output is small for example or the color is completely different, the possibility of being not the specific image is high and even if the specific image based upon them, it is never mistaken for its real thing. Also, if the resolution is low or a irreversible compression method is used, an image mistaken for its real thing is not output in quality because of the deterioration and others of its output image. In such a case, even if recognition processing is omitted, no problem is caused and the processing can be sped up.

Also, if recognition processing is executed by a recognition unit at the resolution lower than the resolution of output for example and as a result, the possibility of including the specific image in image data is higher than a predetermined level, recognition processing at higher resolution by the recognition unit is enabled. As time required for recognition processing is generally increased according to the resolution of an image, recognition processing is executed at low resolution beforehand and if the possibility of including the specific image is low, the recognition processing is terminated. Hereby, recognition processing can be executed at high speed in the normal output of an image. Needless to say, as recognition at high resolution is tried if the possibility of including the predetermined image is higher than predetermined level, the precision is never deteriorated.

If it is determined beforehand whether or not recognition processing is executed by the recognition unit as described above and the recognition processing is executed by the recognition unit or if the result of recognition that the possibility of including the predetermined image is higher than a predetermined level is output from the recognition unit, the processing that output image data is generated based upon image data and is output of an output image data generation unit can be temporarily stopped. Or if the output image data generation unit outputs output image data per predetermined unit, the quantity of output data can be changed. If the recognition unit recognizes the existence of the specific image, the processing of the output image data generation unit is stopped or the specific image is replaced with fixed data or a character string telling that the specific image exists and can be output.

It can be determined in units of page whether recognition processing is executed by the recognition unit or not. Also, even if a raster image is commanded to be separately plotted, a continuous raster image can be determined as one raster image. Hereby, the output of the specific image by a method of commanding the specific image to be divided and to be output can be prevented.

The above-mentioned determination of whether or not recognition processing is executed by the recognition unit and the recognition processing by the recognition unit may also be performed by another device. Also, such processing can be implemented by a program that can be executed by a computer and the program can be provided in a state that it is stored on a storage medium.

### BRIEF DESCRIPTION OF THE DRAWINGS

Preferred embodiments of the present invention will be described in detail based on the followings, wherein:

FIG. 1 is a block diagram showing an example of an image formation device including one embodiment of an image processor according to the invention;

FIG. 2 is a flowchart showing an example of the operation in the example of the image formation device including one embodiment of the image processor according to the invention;

FIG. 3 is an explanatory drawing showing a concrete example of an image formed based upon image data;

FIG. 4 is an explanatory table showing an example of conditions used when the necessity of recognition processing is determined in a preliminary determination unit;

FIGS. 5A, 5B, 5C, and 5D are explanatory drawings showing a concrete example of an image formed if a specific image is included;

FIG. 6 is a block diagram showing another example of the image formation device including one embodiment of the image processor according to the invention;

FIG. 7 is a flowchart showing an example of the operation in another example of the image formation device including one embodiment of the image processor according to the invention;

FIG. 8 is a flowchart showing another example of the operation in another example of the image formation device including one embodiment of the image processor according to the invention;

FIG. 9 is a block diagram showing an example of another system including one embodiment of the image processor according to the invention;

FIG. 10 is a block diagram showing an example of further another system including one embodiment of the image processor according to the invention;

FIG. 11 is an explanatory drawing showing an example of a storage medium storing a computer program in the case where the function of the image processor according to the invention is implemented by the computer program;

FIG. 12 is a flowchart showing an example of printing operation in the case where processing for recognizing an image of which the printing is prohibited is executed in a printer; and

FIG. 13 is a flowchart showing another example of printing operation in the case where the processing for recognizing the image of which the printing is prohibited is executed in the printer.

### DETAILED DESCRIPTION OF THE PREFERRED EMBODIMENTS

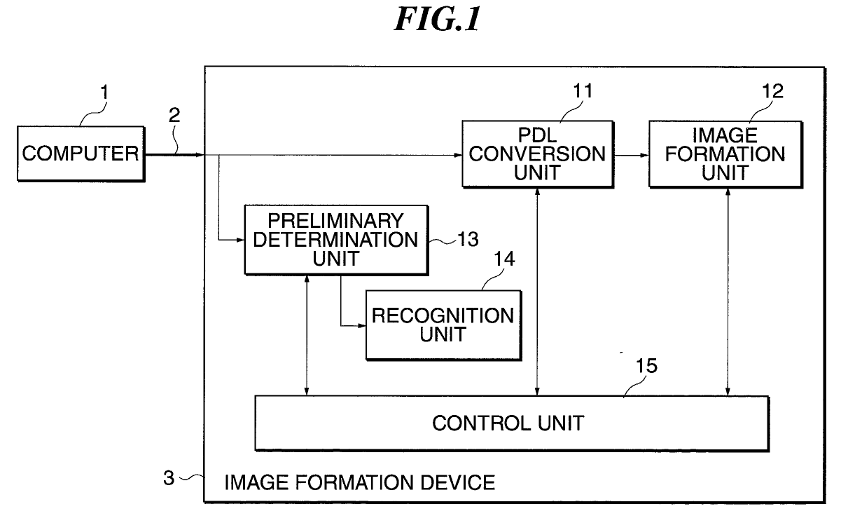

FIG. 1 is a block diagram showing an example of an image formation device including one embodiment of an image processor according to the invention. As shown in FIG. 1, a reference number 1 denotes a computer, 2 denotes a telecommunication line, 3 denotes an image formation device, 11 denotes a PDL conversion unit, 12 denotes an image formation unit, 13 denotes a preliminary determination unit, 14 denotes a recognition unit and 15 denotes a control unit. In this example, the image processor according to the invention is provided in the image formation device 3.

The computer 1 represents image data to be printed by the image formation device 3 in PDL and outputs it to the image formation device 3 via the telecommunication line 2. The telecommunication line 2 may also be a network such as LAN and a public line and may also be directly connected by a cable.

The image formation device 3 includes the PDL conversion unit 11, the image formation unit 12, the preliminary determination unit 13, the recognition unit 14, the control unit 15 and others. The PDL conversion unit 11 converts image data described in PDL sent from the computer 1 to output image data and outputs it. The PDL conversion unit converts PDL to a raster image for example and can output it to the image formation unit 12. The PDL conversion unit 11 can temporarily stop conversion to output image data or can temporarily stop the output of output image data to the image formation unit 12 when it is determined in the preliminary determination unit 13 that processing for recognizing a specific image is executed by the recognition unit 14 or in the case where the result of recognition that the possibility of including a predetermined image is higher than a predetermined level is output from the recognition unit 14 is acquired. There is also a case where output image data is output per predetermined unit such as every band depending upon the image formation unit 12, however, in such a case, the quantity of output data can be changed. Further, if it is recognized by the recognition unit 14 that the specific image exists, the processing of the PDL conversion unit 11 is stopped at that time. Or the corresponding page or the specific image may also be replaced with fixed data such as a blank sheet and a black solid part and may also be replaced with a character string telling that the specific image exists. Needless to say, an arbitrary well-known method can be used for operation when the specific image is recognized.

The image formation unit 12 forms an image on paper for example based upon output image data converted by the PDL conversion unit 11.

The preliminary determination unit 13 checks to see whether or not a plotted object meeting a certain condition exists in PDL output from the computer 1 and commands the recognition unit 14 to execute recognition processing only if the certain condition is met. For a plotted object formed as the specific image, a raster image is the most and for example, a raster image may also be passed to the recognition unit 14. Further, if a raster image is not formed as the specific image because of the size, the resolution, the color and the compression format after output for example of raster images or if a raster image can be clearly discriminated from the proper specific image, the raster image is not an object of recognition by the recognition unit 14.

If the output size is small even if an image to be image data is the specific image, the image is never used for a bad purpose in the size even if it is formed by the image formation unit 12. Even if the specific image is formed in the case where the resolution is low, it is hardly mistaken for its real thing because of the quality of the formed image and the specific image is not required to be recognized. Also, if the number of colors is small such as the specific image is color and its image data is black and white and if used colors are greatly different from those of the specific image, the image is often not the specific image and even if the image is originally the specific image, the formed image looks different from its real thing and is never mistaken for the real thing. Further, as an image compressed using an irreversible compression method for a compression method is deteriorated after expansion, it is hardly mistaken for its real thing because of its quality even if the specific image is formed. In these cases, the specific image is not required to be recognized and recognition processing can be omitted.

When a raster image is determined, it is desirable that continuous plural raster images are determined as one raster image. For example, a case where the specific image is divided and is passed from the computer 1 as plural plotted objects is also conceivable. In such a case, the possibility of being the specific image can also be determined by determining continuous plural raster images as one raster image if the specific image is divided.

Also, an image of lower resolution than the resolution of output image data for the PDL conversion unit 11 for example to output to the image formation unit 12 is generated and can be sent to the recognition unit 14 so as to execute recognition processing preliminarily. If the possibility of including the specific image in image data is higher than a predetermined level as a result of the preliminary recognition processing, recognition processing can be executed at higher resolution by the recognition unit 14. As time required for recognition processing by the recognition unit 14 generally often depends upon the resolution of an image, recognition processing is executed at low resolution beforehand and if the possibility of including the specific image is low, the recognition processing can be sped up by terminating it at that time. As recognition at high resolution is performed if the possibility of including the predetermined image is higher than a predetermined level, the precision is not deteriorated. An image at low resolution may also be generated by the preliminary determination unit 13 separately from the PDL conversion unit 11 or may also be generated based upon output image data converted by the PDL conversion unit 11.

The determination described above in the preliminary determination unit 13 can be performed for every image data piece described in PDL in units of page for example. Also, if a mode when an image is formed is specified together with image data described in PDL or by an operating unit of the body not shown and others, determination may also be performed in the specified mode. A formed image is not mistaken for its real thing as regards the quality in a draft mode for example and in such a case, recognition processing by the recognition unit 14 is not required. Therefore, it may also be switched depending upon the specified mode whether the determination processing described above is to be executed or not.

The preliminary determination unit 13 determines whether or not processing for recognizing the specific image is to be executed by the recognition unit 14 depending upon whether or not a certain condition is met as described above. Hereby, if the specific image is clearly not included or if it is conceivable that the possibility of mistaking a formed image for the specific image is low, it can be set not to perform recognition processing. If the preliminary determination unit 13 determines that recognition processing is to be executed by the recognition unit 14, the PDL conversion unit 11 can be commanded to temporarily stop the generation or the output of output image data. The various determinations described above can be used with them combined and the object of recognition processing by the recognition unit 14 can be further narrowed down.

The recognition unit 14 applies processing for recognizing the specific image to a determined object if it is determined by the preliminary determination unit 13 that the object meets a certain condition or a raster image on the page or their images of low resolution. A method of recognition processing is arbitrary and well-known various methods can be used. In recognition processing, even if the specific image exists in a part of an image, it is desirable that the result of recognition that the specific image exists is output. Also, it is desirable that the possibility of including the specific image can be output depending upon ratio or probability and others corresponding to a case that an image of low resolution is input as described above and a case that a part of the specific image is input. If the recognition unit 14 recognizes the specific image, it may also be informed to the PDL conversion unit 11 and the image formation unit 12 that the specific image is recognized. Needless to say, the possibility of including the specific image may also be informed the PDL conversion unit 11 and the image formation unit 12.

The control unit 15 controls the operation of the whole image formation device 3. Particularly, in the example shown in FIG. 1, the control unit controls so that determination processing by the preliminary determination unit 13, recognition processing by the recognition unit 14, processing for converting image data by the PDL conversion unit 11 and image formation processing by the image formation unit 12 are operated in parallel. At this time, the control unit 15 receives each result of the determination processing by the preliminary determination unit 13 and the recognition processing by the recognition unit 14 and controls the operation of the PDL conversion unit 11 and the image formation unit 12 according to the results. If it is determined in the preliminary determination unit 13 that a part of image data meets the certain condition and if it is recognized in the recognition unit 14 that the possibility of including the specific image in image data is higher than predetermined level, the control unit can control so that processing in the PDL conversion unit 11 is temporarily stopped. Also, if the specific image is recognized in the recognition unit 14, the control unit can control so that the PDL conversion unit 11 and the image formation unit 12 stop the processing and can control so that the PDL conversion unit 11 replaces a page including the specific image and a part of the specific image with fixed data and outputs a character string to be a message. Needless to say, the preliminary determination unit 13 and the recognition unit 14 may also directly send the result of determination and the result of recognition to the PDL conversion unit 11 and the image formation unit 12.

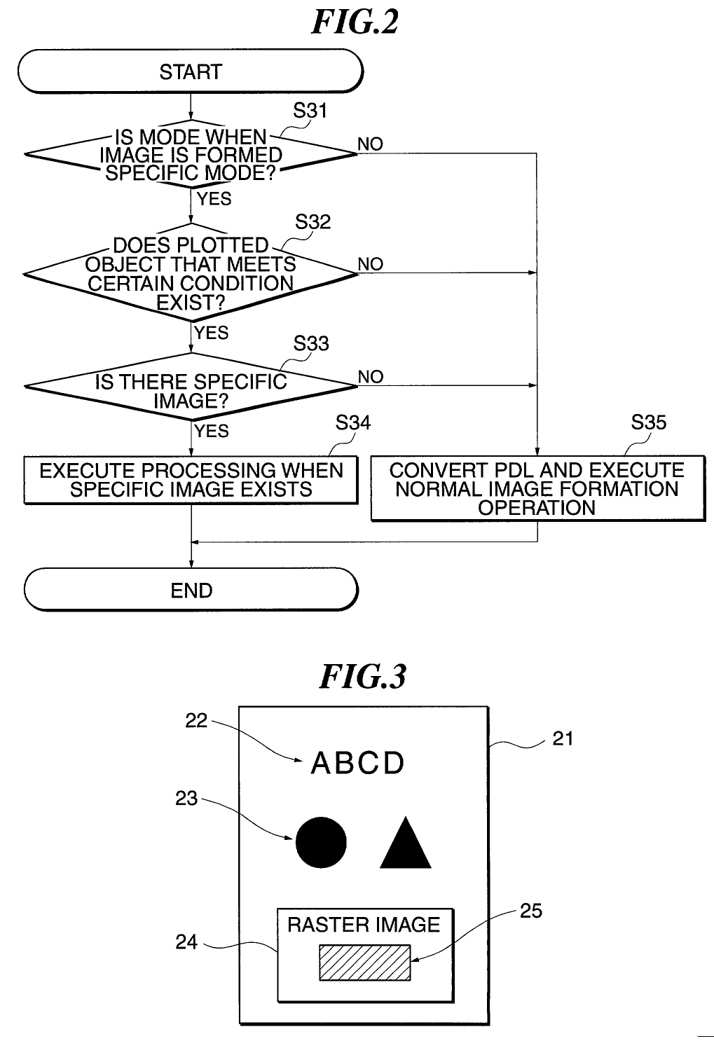

FIG. 2 is a flowchart showing an example of the operation in the example of the image formation device including one embodiment of the image processor according to the invention. When image data based upon which an image is to be formed is received from the computer 1, it is first judged in a step S31 whether a mode when the image is formed is a predetermined mode or not. If the mode is not the predetermined mode such as a draft mode, no later determination processing by the preliminary determination unit 13 and no later recognition processing by the recognition unit 14 are applied to the image data, in a step S35, as in a normal image formation device, the image data is converted by the PDL conversion unit 11, output image data is generated and an image is formed on paper for example by the image formation unit 12.

If a mode when an image is formed is the predetermined mode, the preliminary determination unit 13 determines in a step S32 whether or not a plotted object meeting the certain condition exists in image data per output page. The preliminary determination unit 13 can perform various determination as described above. If no plotted object meeting the certain condition exists in the image data of an output page, the image data is converted and output image data is generated by the PDL conversion unit 11 in a step S35 as in a normal image formation device, and an image is formed on paper for example by the image formation unit 12.

If a plotted object meeting the certain condition in the image data of an output page exists, recognition processing is executed by the recognition unit 14 in a step S33. At this time, the operation of the PDL conversion unit 11 and the image formation unit 12 may also be temporarily stopped. If the result of recognition that the image is not the specific image is acquired as a result of the recognition processing, image data is converted by the PDL conversion unit 11 and output image data is generated in S35 as in a normal image formation device, and an image is formed on paper for example by the image formation unit 12. If the result of recognition that the image is the specific image is acquired, processing when the specific image is recognized is executed in a step S34. For example, the operation of the PDL conversion unit 11 and the image formation unit 12 is stopped, and processing such as one page or a part of the specific image is blanked, they are filled with a fixed pattern such as a black solid part and a character string to be a message that printing is prohibited because of the specific image is inserted is applied to the PDL conversion unit 11. Or control that the image formation unit 12 is commanded to forcedly eject paper and in the case of color recording, specific color is applied and specific color is not applied may also be performed. As described above, the specific image is prevented from being formed as it is.

The processing described above is executed per page. Heretofore, recognition processing was necessarily executed by the recognition unit 14, however, as described above, in the invention, the necessity of recognition processing is determined by the preliminary determination unit 13 before recognition processing, only an image requiring recognition processing is passed to the recognition unit 14 and recognition processing is applied to it. Therefore, in normal image formation, in most cases, recognition processing in the recognition unit 14 is not required and an image can be formed at high speed. Also, as recognition processing is executed by the recognition unit 14 if the execution of recognition processing is desired, recognition precision is never deteriorated.

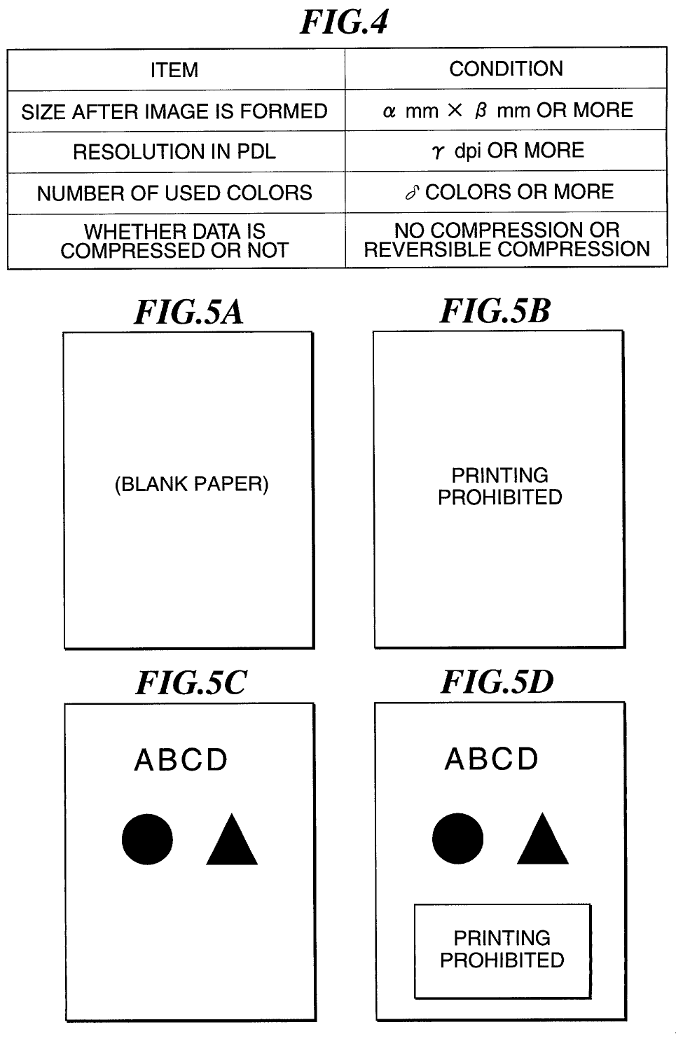

The operation described above will be described based upon concrete image data below. FIG. 3 is an explanatory drawing showing a concrete example of an image formed based upon image data, FIG. 4 is an explanatory drawing showing an example of a condition used when the necessity of recognition processing is determined by the preliminary determination unit and FIGS. 5 are explanatory drawings showing concrete example of images formed if the specific image is included. As shown in FIG. 3, a reference number 21 denotes image data, 22 denotes a character, 23 denotes a graphic, 24 denotes a raster image and 25 denotes the specific image. In this case, image data for forming an image shown in FIG. 3 is considered as an example. In the image shown in FIG. 3, characters “A, B, C, D” 22, graphics 23 such as a circle and a triangle and an object including the raster image 24 are included in the image data 21. Also, the specific image 25 is included in the raster image 24.

When the image data 21 for the image shown in FIG. 3 to be formed is input, a mode in image formation is first determined. In this case, the mode shall be a predetermined mode such as a normal image formation mode and a high quality mode. In that case, determination is performed by the preliminary determination unit 13. If the raster image for example is determined by the preliminary determination unit 13, recognition processing by the recognition unit 14 is not applied to the character 22 and the graphic 23. Also, it is further determined whether or not the raster image 24 is suitable for conditions shown in FIG. 4.

In the example of the conditions shown in FIG. 4, for the raster image, only a raster image that meets conditions such as the size after image formation is α×β mm or more, the resolution in PDL is γ dpi or more, the number of used colors is δ or more and no compression or reversible compression is applied for data compression is extracted as the object of recognition processing. As described above, in a raster image the size after image formation of which is small, the resolution of which is low, the number of used colors of which is small and to which irreversible compression is applied, a formed image, even if it is the specific image, is hardly mistaken for the specific image. Therefore, recognition processing by the recognition unit 14 is not applied to a raster image which does not meet any of these conditions.

If the raster image 24 shown in FIG. 3 meets the conditions shown in FIG. 4, recognition processing by the recognition unit 14 is applied to the raster image 24. As described above, in the image data 21 shown in FIG. 3, recognition processing is applied to nothing except the raster image 24.

The specific image 25 exists in the raster image 24. Therefore, the recognition unit 14 recognizes the specific image 25 and the result of recognition that the specific image exists is output. For example, the PDL conversion unit 11 executes processing when the specific image exists according to the result that the specific image exists of recognition by the recognition unit 14. As shown in FIG. 5A for example, the whole page can be blanked or as shown in FIG. 5B, a message that printing is prohibited can be formed. Or, no image is formed in an area of the raster image in which the specific image is included or an area of the specific image as shown in FIG. 5C and a message that printing is prohibited can also be inserted as shown in FIG. 5D. Specific working may also be applied not to mistake for the specific image without limiting to these output methods. Or, image formation operation itself may also be stopped.

In the example shown in FIG. 3, only one raster image is included, however, plural raster images may exist. If plural raster images exist on one page, image data described in PDL as a raster image acquired by dividing the original one raster image may be generated. In such a case, each raster image is smaller than the specific image and is often not recognized as the specific image in partial recognition. To cope with such a case, it is desirable that the preliminary determination unit 13 and the recognition unit 14 determine whether a continuous raster image meets the specific conditions or not as one raster image as a result of converting PDL when plural raster images exist on the same page and the recognition processing of whether the image is the specific image or not is executed.

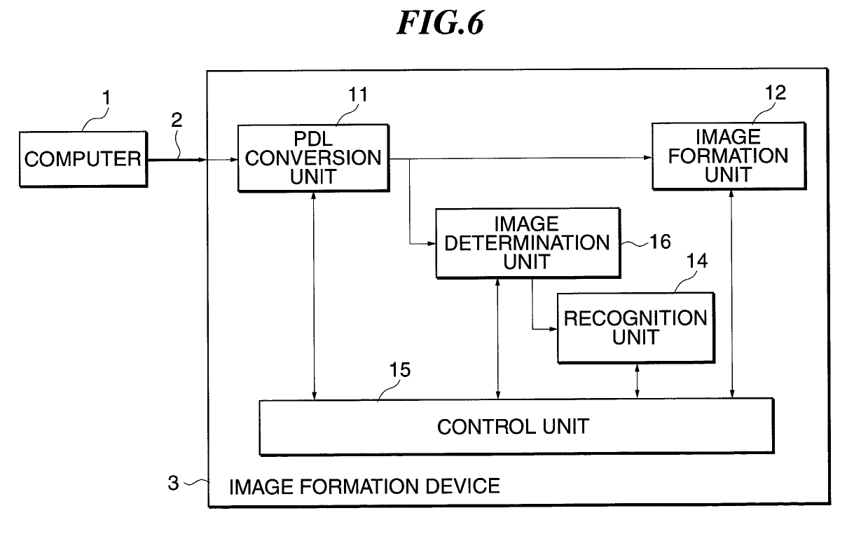

FIG. 6 is a block diagram showing another example of the image formation device including one embodiment of the image processor according to the invention. The same reference number is allocated to the similar part in FIG. 6 to that in FIG. 1 and the description is omitted. A reference number 16 denotes an image determination unit. In this example, determination by the image determination unit 16 is performed before recognition processing by a recognition unit 14 is applied to output image data converted by the PDL conversion unit 11.

An image formation unit 12 forms an image per predetermined unit as in a serial printer for example. In such a case, if image formation is started after processing for determining in the preliminary determination unit 13 image data the image formation speed of which is slow and which is described in PDL for one page and for recognizing in the recognition unit 14 if necessary is all finished, time required for image formation is further extended. Therefore, it is desirable that recognition processing is executed in the recognition unit 14, outputting per predetermined unit.

The image determination unit 16 passes output image data every predetermined unit normally passed to the image formation unit 12 to the recognition unit 14, commands the recognition unit to execute processing for recognizing the specific image and receives the probability P of including the specific image as the result of recognition. As the quantity of data is small in processing for recognizing output image data per predetermined unit, the processing can be executed at relatively high speed. When the probability P is determined and the probability P of including the specific image becomes high, the PDL conversion unit 11 is commanded to change a predetermined unit in which output image data is output and when the probability P further becomes high, the output of the output image data is temporarily stopped at that time and the recognition unit 14 is commanded to perform the recognition of the whole page for example.

Image formation processing can be sped up by controlling a range of output image data to which recognition processing by the recognition unit 14 is to be applied by the image determination unit 16 as described above, compared with a case where recognition processing is applied to the whole images of one page and then image formation is started.

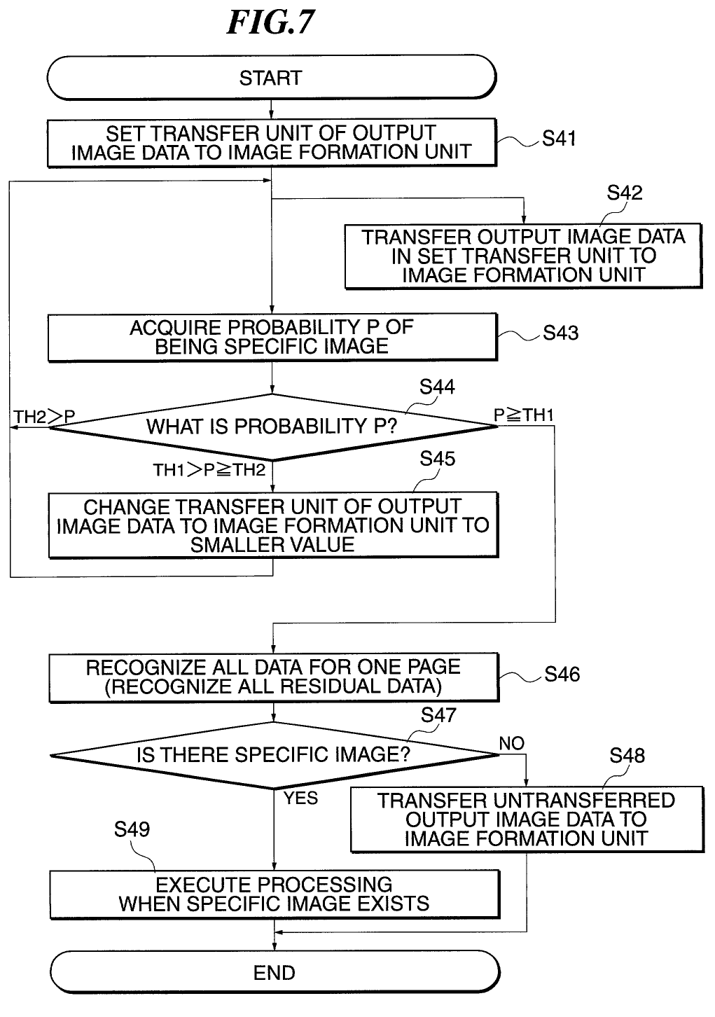

FIG. 7 is a flowchart showing an example of the operation in another example of the image formation device including one embodiment of the image processor according to the invention. A predetermined unit in which output image data is transferred to the image formation unit 12 is set in a step S41. Output image data in the predetermined unit converted by the PDL conversion unit 11 is transferred to the image formation unit 12 in a step S42 to form an image, is transferred to the image determination unit 16 in a step S43 and processing for recognizing the output image data in the predetermined unit is executed by the recognition unit 14. The image determination unit 16 receives the probability P of including the specific image from the recognition unit 14 as the result of recognition and determines the probability P in a step S44.

Determination is performed by comparing the probability P and a threshold TH1 or a threshold TH2 (TH1>TH2). If the probability P of including the specific image is smaller than the threshold TH2, it is considered that the possibility of including the specific image in output image data in the predetermined unit is low and image formation is continued as it is.

If the probability P of including the specific image is equal to or higher than the threshold TH2 and is smaller than the threshold TH1, it is considered that there is the possibility of including the specific image and the setting of the unit of output image data transferred to the image formation unit 12 is changed so that it is smaller, that is, so that image formation is performed by degrees. Also, in the range of this probability, output image data is stored so that recognition processing by the recognition unit 14 is executed in a range wider by degrees. When the possibility of including the specific image becomes smaller than the threshold TH2 by recognition processing using output image data in a wider range, the operation is returned to normal image formation operation and image formation can be continued.

If the probability P of including the specific image becomes high and exceeds the threshold TH1, it is considered that the possibility of including the specific image is high, the transfer of output image data to the image formation unit 12 by the PDL conversion unit 11 is temporarily stopped, the residual image data is also converted in a step S46 and recognition processing by the recognition unit 14 is executed. The result is determined in a step S47, if no specific image is included, the transfer of output image data to the image formation unit 12 is restarted and the output image data converted in S46 is sequentially output in a step S48. If the specific image is recognized, processing when the specific image exists is executed in a step S49. The processing when the specific image exists can be operated as in S34 shown in FIG. 2.

As described above, in the image formation device that performs image formation every predetermined unit, recognition processing can also be normally executed without loading onto image formation, forming an image. Therefore, when a normal image is formed, the deterioration of the speed due to recognition processing is hardly caused and an image can be formed at high speed.

In the example of the operation shown in FIG. 7, as in FIG. 2, a mode when an image is formed is also determined beforehand and control can be made so that determination processing by the image determination unit 16 and recognition processing by the recognition unit 14 are not executed except in the predetermined mode.

As for another example of the image formation device including one embodiment of the image processor according to the invention, the case where output image data is transferred to the image formation unit 12 per predetermined unit is described above. In addition, if the image formation unit 12 forms an image after the PDL conversion unit 11 generates output image data for one page, recognition processing can also be finished in a short time to speed up normal image formation. For an example of the case, a case that the resolution of an image to which recognition processing is to be applied is varied is shown below.

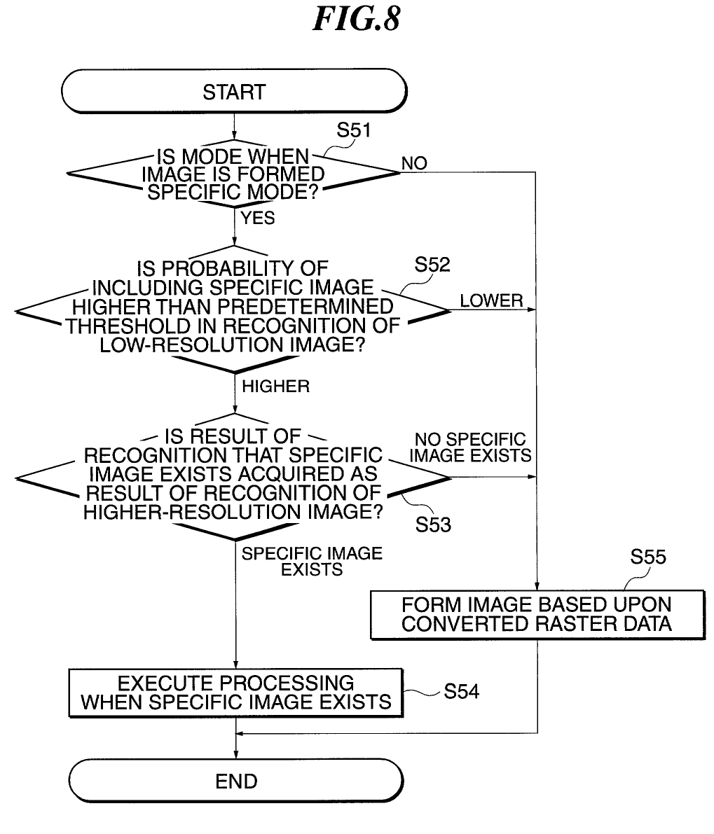

FIG. 8 is a flowchart showing another example of the operation in another example of the image formation device including one embodiment of the image processor according to the invention. When image data based upon which an image is to be formed is received from the computer 1, the PDL conversion unit 11 interprets PDL and executes processing for converting it to output image data. At this time, an image of lower resolution than the resolution in image formation is generated for recognition together with an image of the resolution in image formation. Or, after output image data of the resolution in image formation is generated, the resolution is converted and an image of lower resolution may also be generated.

In a step S51, it is judged whether a mode in image formation is a predetermined mode or not. If the mode is not the predetermined mode, for example in a draft mode, determination processing in the image determination unit 16 and recognition processing in the recognition unit 14 are not executed, the converted output image data is transferred to the image formation unit 12 in a step S55 and an image has only to be formed on paper for example. If the mode is not the predetermined mode, an image of low resolution is not required and afterward, the resolution is not required to be converted.

If the mode in image formation is the predetermined mode, an image of low resolution is first passed from the image determination unit 16 to the recognition unit 14 in a step S52 and processing for recognizing the specific image is executed. In this case, as the resolution of the image is low, the quantity of data is small and time required for recognition processing can be minimized. In this case, the probability P of including the specific image is also received from the recognition unit 14, and if the probability P is equal to or smaller than a predetermined threshold, it is considered that the specific image is hardly included, the converted output image data of the resolution in image formation is transferred to the image formation unit 12 in S55 and an image has only to be formed on paper for example.

If the probability P of including the specific image is higher than the predetermined threshold in processing for recognizing an image of low resolution, it is judged that there is the possibility of including the specific image and more precise recognition processing is executed. Therefore, in a step S53, recognition processing is executed by the recognition unit 14 using an image of higher resolution than the resolution of the image used in the determination in S52, for example an image of the resolution in image formation. When the result that the specific image is not included is acquired as a result of the recognition processing, the converted output image data of the resolution in image formation is transferred to the image formation unit 12 in S55 and an image has only to be formed on paper for example. If the result of recognition that the specific image is included is acquired, processing when the specific image is recognized is executed in a step S54. The processing when the specific image exists can be operated as in S34 shown in FIG. 2.

As described above, as recognition processing is executed only based upon an image of low resolution in normal image formation, delay by processing for recognizing the specific image can be minimized. In the example described above, the processing at two stages by the recognition processing of an image of low resolution and an image of high resolution is executed, however, the invention is not limited to this and processing at three or more stages may also be executed. This example may also be applied to the example shown in FIG. 1, when recognition for a raster image is performed, recognition processing is first applied to a raster image of low resolution as in this example and if there is the possibility of including the specific image, recognition processing at the original resolution or the resolution in image formation can be executed.

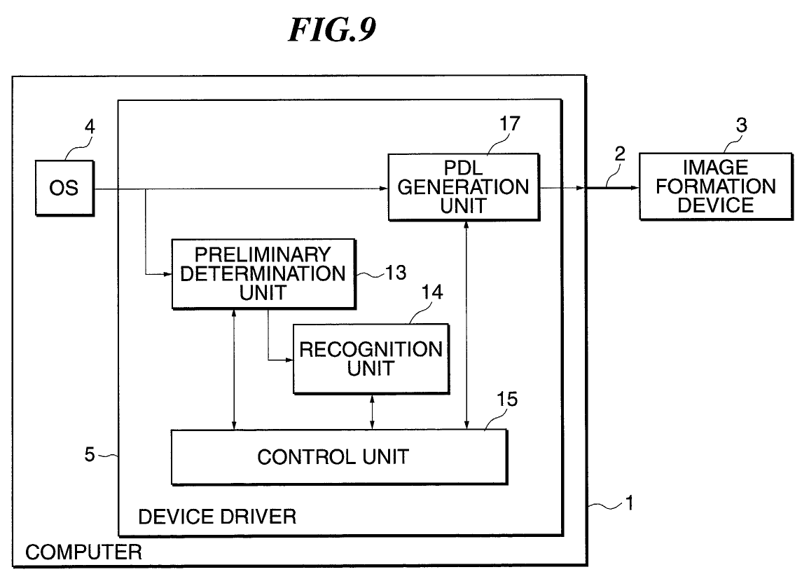

FIG. 9 is a block diagram showing an example of another system including one embodiment of the image processor according to the invention. In FIG. 9, the same reference number is allocated to the similar part to that in FIG. 1 and the description is omitted. A reference number 4 denotes OS, 5 denotes a device driver and 17 denotes a PDL generation unit. In this example, the recognition of the specific image is not performed in an image formation device 3 but the recognition of the specific image is performed on the side of a computer 1 which is a sender of image data. In the computer 1, when image formation is requested in an application program, image data is sent to the device driver 5 via the OS 4.

The device driver 5 is provided with a function that converts the image data passed from the OS 4 to output image data which the image formation device 3 can interpret and transfers it. For example, output image data described in PDL is generated based upon image data passed from the OS 4 and can be transferred to the image formation device 3. This function is provided to the PDL generation unit 17. Needless to say, if the image formation device 3 demands a raster image, the PDL generation unit 17 generates a raster image as in the PDL conversion unit 11 shown in FIG. 1 and can transfer it to the image formation device 3.

A preliminary determination unit 13 determines whether the image data passed from the OS 4 meets a certain condition as described above or not and recognition processing by a recognition unit 14 is applied to the image data that meets the certain condition.

Determination processing in the preliminary determination unit 13 and recognition processing in the recognition unit 14 in the configuration shown in FIG. 9 are similar to those in the configuration shown in FIG. 1 and both cases are different only in that they are executed on the side of the computer 1. Therefore, the detailed description is omitted.

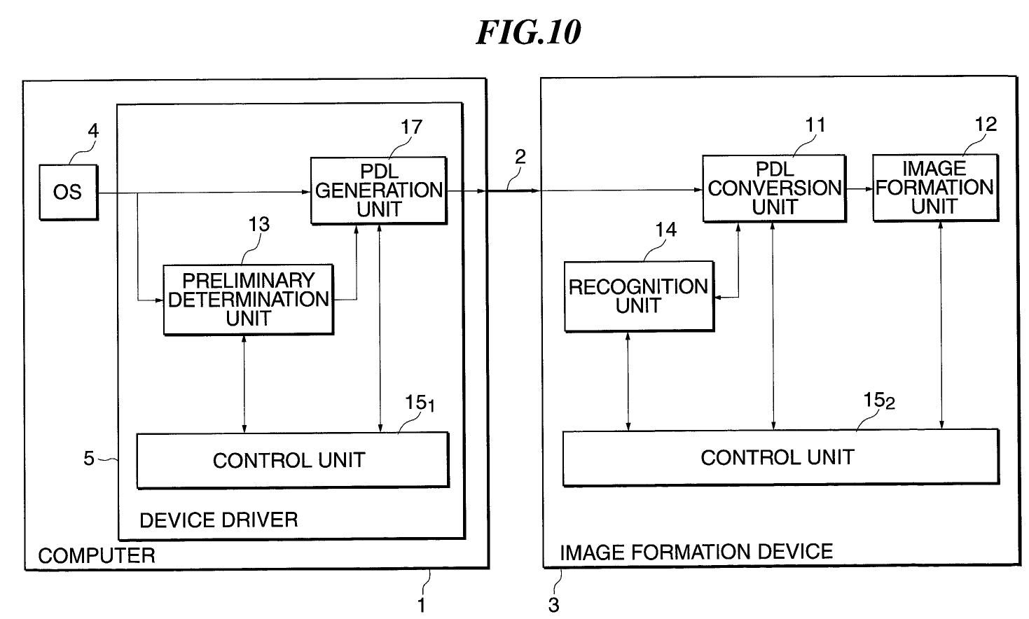

FIG. 10 is a block diagram showing an example of further another system including one embodiment of the image processor according to the invention. Reference numbers in FIG. 10 are similar to those in FIGS. 1 and 9 and the description is omitted. In this example, an image formation device 3 is provided with a recognition unit 14 and the function of a preliminary determination unit 13 is implemented on the side of a computer 1.

The preliminary determination unit 13 provided in a device driver 5 of the computer 1 determines whether image data passed from the OS 4 meets a certain condition as described above or not, adds information that there is the possibility of including the specific image to the image data that meets the certain condition and outputs image data described in PDL to a PDL generation unit 17.

A PDL conversion unit 11 in the image formation device 3 interprets image data described in PDL sent from the computer 1 and if a plotted object to which the information that there is the possibility of including the specific image is added exists in it, the plotted object is passed to a recognition unit 14 and processing for recognizing the specific image is applied to the plotted object. A plotted object to which no information that there is the possibility of including the specific image is added can be developed and output without recognition processing by the recognition unit 14. Hereby, processing time can be significantly reduced, compared with a case where recognition processing is applied to all plotted objects.

The contents of determination processing in the preliminary determination unit 13 and recognition processing in the recognition unit 14 respectively in the configuration shown in FIG. 10 are similar to those in the configuration shown in FIG. 1. Therefore, the detailed description is omitted.

In the configuration shown in FIG. 10, the case where each preliminary determination unit 13 and each recognition unit 14 are provided in the computer 1 and the image formation device 3 is shown. However, the invention is not limited to this and the image processor according to the invention can be implemented in various configuration such as a print server is provided at an intermediate point and functions are dispersed among the computer 1, the print server, the image formation device 3 and others. If functions are dispersed as described above, it is desirable that the result of determination in the preliminary determination unit 13 and the result of recognition in the recognition unit 14 are included in image data described in PDL transferred between each device and a command for transferring image data and are transferred.

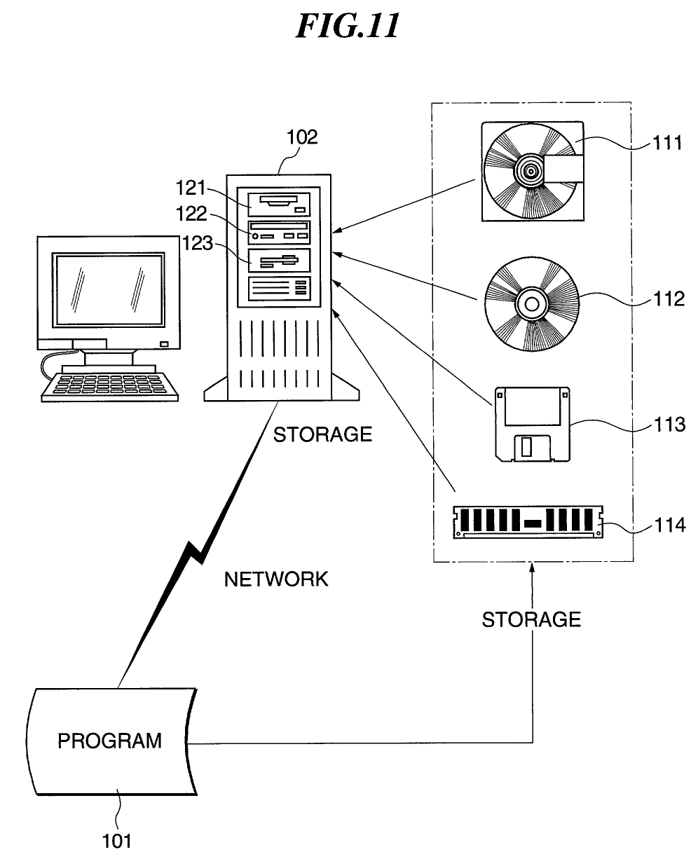

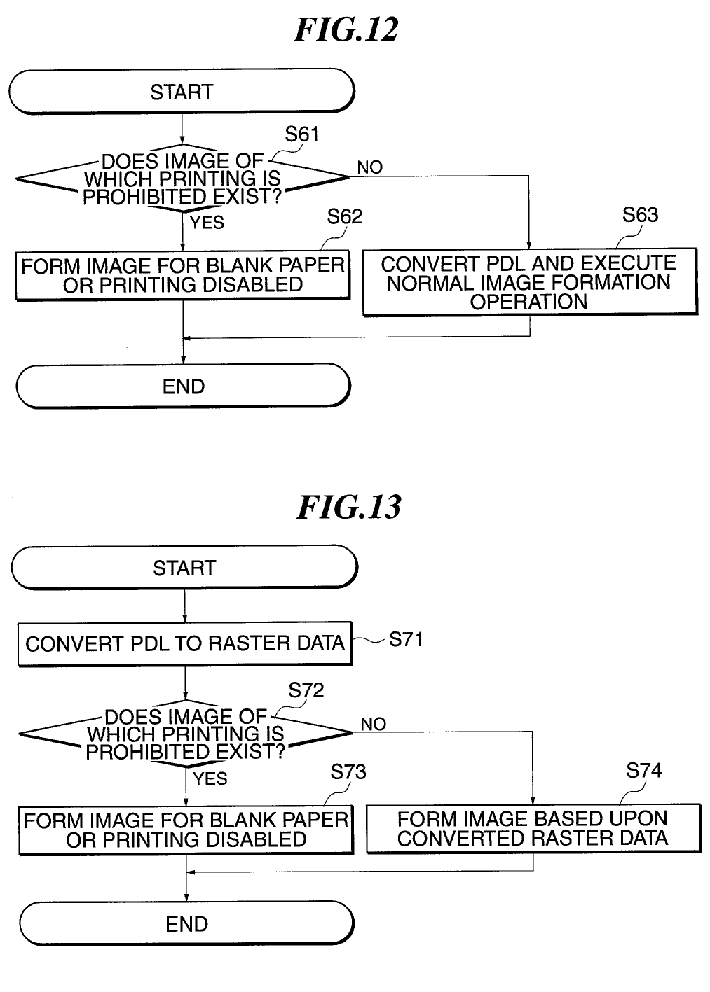

FIG. 11 is an explanatory drawing showing an example of a storage medium storing a computer program in the case where the functions of the image processor according to the invention are realized in the computer program. As shown in FIG. 11, a reference number 101 denotes a program, 102 denotes a computer, 111 denotes a magneto-optical disc, 112 denotes an optical disk, 113 denotes a magnetic disk, 114 denotes a memory, 121 denotes a magneto-optical disk unit, 122 denotes an optical disk unit and 123 denotes a magnetic disk unit.

The functions of the image processor in each embodiment of the invention can also be implemented by the program 101 which can be executed by the computer. In that case, the program 101 and data which the program uses can also be stored on a computer-readable storage medium. The storage medium causes a state that energy such as magnetism, light and electricity is varied according to the contents of the program in a reader provided as one of hardware resources of the computer and can transmit the contents of the program to the reader in a format of a signal corresponding to it. The magneto-optical disc 111, the optical disk 112, the magnetic disk 113, the memory 114 and others can be given as an example. Needless to say, these storage media are not limited to a portable type.

The program 101 is stored in these storage media, the program 101 is read from the computer by installing these storage media in the magneto-optical disc unit 121, the optical disk unit 122, the magnetic disk unit 123 or a memory slot not shown respectively of the computer 102 and the functions of the image processor according to the invention can be executed. Or, the storage medium is installed in the computer 102 beforehand, the program 101 is transferred to the computer 102 via a network for example, is stored on the storage medium and may also be executed.

As clear from the above description, according to the invention, as recognition processing is executed only if image data or a plotted object in image data meets a certain condition, recognition processing in the case where the image is clearly different from the specific image for example can be omitted and the processing speed of the whole can be enhanced. Needless to say, as recognition processing is executed if there is the possibility of including the specific image, the precision of recognizing the specific image is never deteriorated and there is effect that the formation of the specific image can be prevented.

The entire disclosure of Japanese Patent Application No. 2000-127995 filed on Apr. 27, 2000 including specification, claims, drawings and abstract is incorporated herein by reference in its entirety.

What is claimed is:

1. An image processor provided with a function for recognizing a specific image in input image data, comprising:
a determination unit that determines whether a raster image exists in the image data or not and outputs the raster image if the raster image exists; and
a recognition unit that recognizes the specific image in the raster image output from the determination unit.

2. An image processor provided with a function for recognizing a specific image in input image data, comprising:
a recognition unit that recognizes the specific image; and
a determination unit that determines whether the image data includes a predetermined characteristic or not and commands the recognition unit to recognize the specific image if the predetermined characteristic is included.

3. An image processor according to claim 2, wherein:
the determination unit determines whether the raster image in the image data has the predetermined characteristic or not.

4. An image processor according to claim 3, wherein:
the determination unit determines whether plural raster images are continuous or not if the plural raster images exist in the image data and determines whether or not the raster images determined as being continuous have the predetermined characteristic as one raster image.

5. An image processor according to claim 3, wherein:
the determination unit uses the size of an output raster image as the predetermined characteristic for making the determination.

6. An image processor according to claim 3, wherein:
the determination unit uses the resolution of a raster image as the predetermined characteristic for making the determination.

7. An image processor according to claim 3, wherein:
the determination unit uses the number of colors included in a raster image as the predetermined characteristic for making the determination.

8. An image processor according to claim 3, wherein:
the determination unit uses a compression format of a raster image as the predetermined characteristic for making the determination.

9. An image processor provided with a function for recognizing a specific image in input image data, comprising:
a recognition unit that recognizes the specific image; and
a determination unit that commands the recognition unit to execute recognition processing at a lower resolution than the resolution of output, determines the result and commands the recognition unit to execute recognition processing at a higher resolution if the possibility of including the specific image in the image data is higher than a predetermined level.

10. An image processor according to claim 1, further comprising:
an output image data generation unit that generates output image data based upon the image data and outputs it, wherein:
the output image data generation unit temporarily stops the generation or the output of the output image data if the determination unit determines that recognition processing by the recognition unit is required.

11. An image processor according to claim 1, further comprising:
an output image data generation unit that generates output image data based upon the image data and outputs it, wherein:
the output image data generation unit temporarily stops the generation or the output of the output image data if the determination unit determines that the possibility of including a specific image in the image data is higher than a predetermined level as a result of recognition processing by the recognition unit.

12. An image processor according to claim 1, further comprising:
an output image data generation unit that generates output image data per predetermined unit based upon the image data and outputs it, wherein:
the determination unit executes processing for making determination on image data per predetermined unit or in a predetermined unit being processed; and
the output image data generation unit changes the quantity of the output image data if the determination unit determines, as a result of recognition processing by the recognition unit, that the possibility of including the specific image in the image data is higher than a predetermined level.

13. An image processor according to claim 10, wherein:
the output image data generation unit stops the generation or the output of the output image data if the recognition unit recognizes the existence of the specific image.

14. An image processor according to claim 10, wherein:
the output image data generation unit outputs fixed data as the output image data if the recognition unit recognizes the existence of the specific image.

15. An image processor according to claim 10, wherein:
the output image data generation unit outputs a character string telling that the existence of the specific image is recognized as the output image data if the recognition unit recognizes the existence of the specific image.

16. An image processor according to claim 1, further comprising:
an output image data generation unit that generates output image data based upon the image data and outputs it, wherein:
the output image data generation unit stops the generation or the output of the output image data if the recognition unit recognizes the existence of the specific image.

17. An image processor according to claim 10, wherein:
the determination unit determines a mode for generating the output image data by the output image data generation unit and commands the recognition unit to execute recognition processing only if the mode is a predetermined mode.

18. An image processor according to claim 1, wherein:
the determination unit executes determination processing in units of page.

19. An image processor provided with a function for recognizing a specific image in input image data, comprising:
a recognition unit that recognizes the specific image; and
a determination unit that determines a mode for outputting the image data, wherein:
the determination unit commands the recognition unit to execute recognition processing if the mode is a predetermined mode.

20. An image processor that generates output image data based upon input image data and outputs it to a device provided with a function for recognizing a specific image, comprising:
a determination unit that determines whether the input image data includes a predetermined characteristic or not; and
an output image data generation unit that generates output image data based upon the input image data and outputs it with added information that there is the possibility of including the specific image in the output image data if the determination unit determines that the input image data includes the predetermined characteristic.

21. An image processor provided with a function for recognizing a specific image in input image data, comprising:
a recognition unit that recognizes the specific image; and
a determination unit that determines whether or not information that there is the possibility of including the specific image in the image data exists, wherein:
the determination unit commands the recognition unit to execute recognition processing if the information exists.

22. A computer-readable storage medium that stores a program for commanding a computer for image processing to execute the functions of:
determining whether a raster image exists in input image data or not and outputting the raster image if the raster image exists; and
recognizing a specific image in the output raster image.
